(19) United States
(12) Patent Application Publication
(10) Pub. No.: US 2004/0116066 A1
(43) Pub. Date: Jun. 17, 2004

(54) Signal mixers

(76) Inventor: William Mark Siddall, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/416,391

(22) PCT Filed: Nov. 9, 2001
(86) PCT No.: PCT/NZ01/00252

(30) Foreign Application Priority Data
Nov. 9, 2000 (NZ) 508053

(51) Int. Cl. H04K 3/00

(52) U.S. Cl. 455/1

(57) ABSTRACT

The present invention relates to a double balanced diode mixer in which an output transformer (22) is replaced by an equivalent circuit (50) which approximates the functionality of the output transformer (21). The circuit includes a LCR network (50) which receives a mixed differential input signal from a diode mixer (21) and generates a single ended output signal and further implements a diplexer which terminates the RF input signal.

### FIELD OF THE INVENTION

This invention relates to circuits for mixing radio signals and in particular to double balanced diode mixers for generating an IF output signal from an RF input signal. It will be appreciated however that the invention is not limited to use with only double balanced diode mixers. The invention may also be implemented for single balanced mixers, doubly doubly balanced mixers and harmonic mixers, for example.

### BACKGROUND TO THE TNTION

Double balanced diode mixers (DBDM) are widely used in telecommunications equipment for converting an input message signal with a particular carrier frequency to an output message signal with a different carrier frequency.

A typical DBDM circuit comprises an input transformer or transformer for receiving an input signal, for example a radio frequency (RF) message signal. The transformer has a differential output for providing two opposite phase output signals, which are fed into two nodes of a diode ring. Two remaining nodes of the diode ring are connected to a differential input of a second or output transformer, which includes a centre tap for a local oscillator (LO) signal on a primary winding, and a single ended output on a secondary winding which contains a mixed output signal.

The diode ring mixes the LO signal with the RF message signal to produce a signal which includes various components including two intermediate frequency (IF) message signals. The output IF message signals have carrier frequencies of ±F_{IF}=±F_{LO}±F_{RF} respectively. A DBDM arrangement will typically have an input filter circuit on the front-end for conditioning the RF input message signal, and also an output filter circuit or diplexer on the backend for removing the undesired components of the mixed signal and to terminate the RF signal in a load. The diplexer can be tuned to one of the IF carrier frequencies to pass the desired IF signal to the output.

The diode ring mixer, input filter and diplexer of a DBDM mixer can be constructed in a compact manner using surface mount and/or integrated circuit technology. However the input and output transformers are by nature bulky devices which increase the overall size of a DBDM mixer.

### SUMMARY OF THE INVION

It is an object of the present invention to remove the need for an output transformer of a DBDM by implementing an equivalent circuit which approximates the functionality of the transformer, or at least to provide an alternative to existing mixer systems. In general terms, the invention provides a circuit which combines the functionality of the diplexer with that of the output transformer. In one embodiment of the invention the circuit provides a LCR network which approximates the functionality of a transformer to receive a mixed differential input signal, generate a single ended output signal and further includes a diplexer portion which suitably terminates the RF input signal, and alters off RF and LO components to extract an IF output message signal. In an alternative embodiment the circuit could be implemented using a microstrip arrangement.

In one aspect the invention may be said to consist in an output stage for a mixing circuit including inputs for differential input signals, an output for a single ended output signal, and a passive network coupled between the output and inputs, wherein the network emulates a combined function of a transformer coupled to a diplexer to produce a single ended output signal from the differential input signals.

The invention may also be said to consist in any alternative combination of parts or features as described or shown in the accompany drawings. Known equivalents of these parts or features not expressly set out are nevertheless deemed to be included.

BRIEF DESCRIPTION OF THE DRAWINGS

Preferred embodiments of the invention will now be described with reference to the accompanying figures, of which:

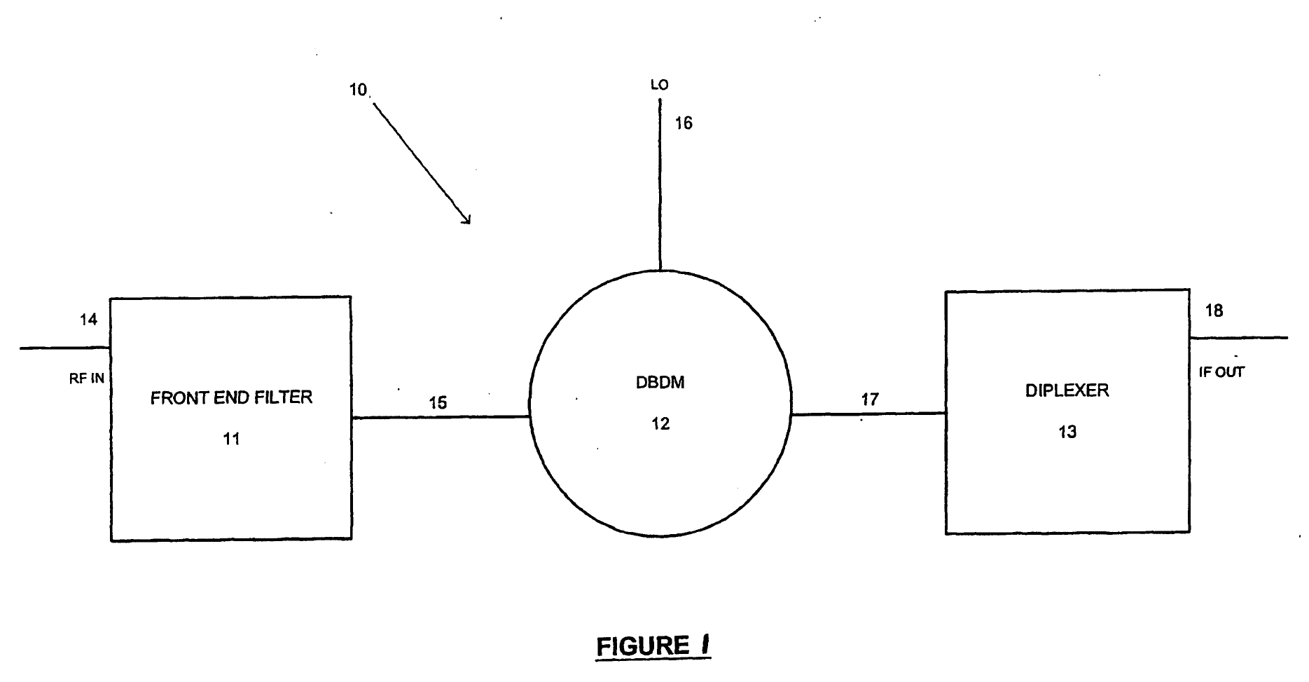

FIG. 1 is a block diagram showing the input, DBDM and output stages of a mixing circuit,

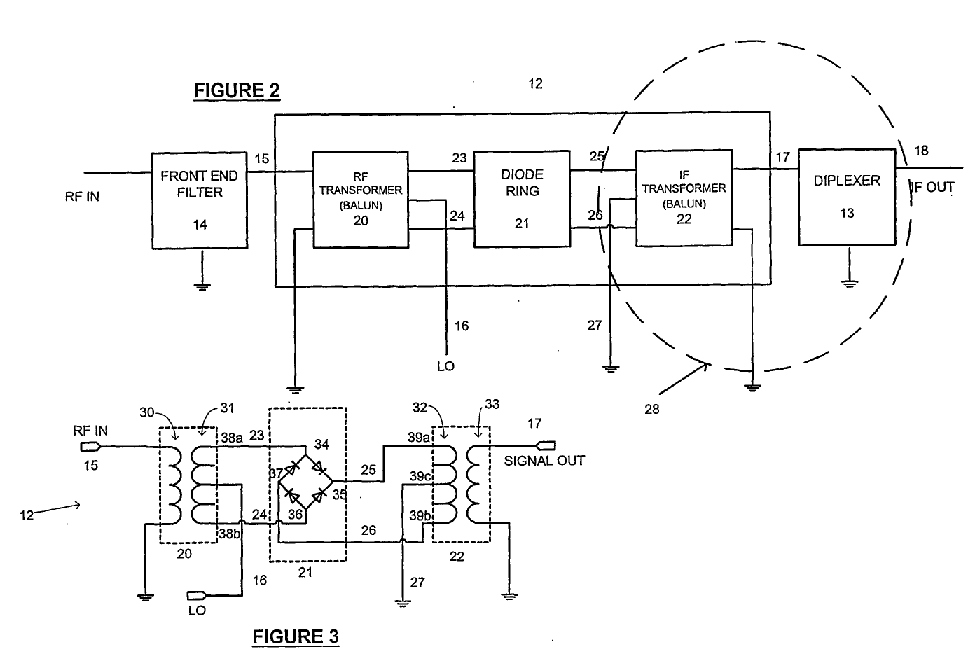

FIG. 2 shows in further detail the DBDM stage of the circuit,

FIG. 3 shows a circuit diagram of the DBDM stage,

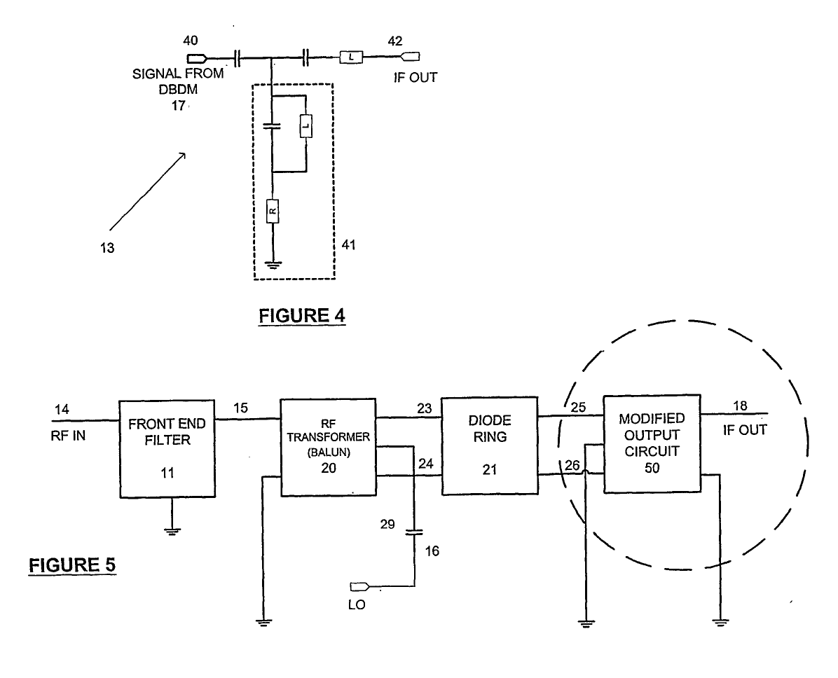

FIG. 4 shows a circuit diagram of the output stage (diplexer),

FIG. 5 shows a block diagram of a modified output stage which implements the combined functionality of a diplexer and differential output transformer, and

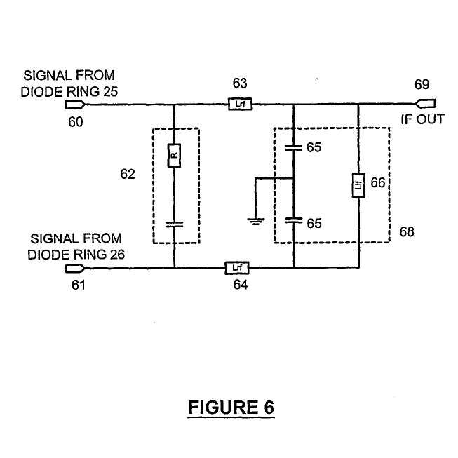

FIG. 6 shows a circuit diagram of a preferred embodiment of the modified output stage.

### DETAILED DESCRPTION OF THE PREPERED MODTS

Referring to the drawings it will be appreciated that an output circuit according to the invention can be implemented in various forms. The following examples are given by way of example only. It will also be appreciated that details relating to filter design and component selection will be understood by those skilled in the art and need not be described in detail here. It should also be appreciated that although illustrated and described as a down conversion mixer, the DBDM is well know to those skilled in the art as a bi-directional mixer and can be equally used as an up-conversion mixer, modulator or demodulator. The output circuit can be used in conjunction with the input circuit for a mixing circuit which is disclosed in WO 02/39578.

FIG. 1 shows the general structure of a existing mixing circuit 10 which implements a DBDM 12. The operation of such a circuit will be known to those skilled in the art although will be briefly explained for reasons of clarity in the description overall. The circuit includes a front-end filter 11 which has a single ended input for receiving, for example, a RF input message signal 14. The filter 11 performs signal conditioning on the input signal 14 to remove undesirable noise and/or distortion. The filtered signal 15 is then passed to the DBDM 12 where an externally generated LO signal 16 is mixed with the filtered signal 15 to produce a mixed signal 17 which contains various components as a result of the mixing operation. The mixed signal is passed to a diplexer 13 where all the undesired components, including the original RE message signal 15 and LO signal 16 are removed to provide a single ended IF output message signal 18 which can be used as required by the remaining portion of telecommunications equipment in which the mixer is being implemented.

FIG. 2 shows the DBDM 12 in further detail. The filtered signal 15 is passed into one input terminal of a transformer 20 of which the other input terminal is grounded. The transformer 20 generates a differential output 23, 24 on a secondary winding, one output comprising the filtered signal 15 and another comprising the same signal but phase shifted by 180°. The LO 16 signal is fed into an input centre tap of the transformer 20. Each output 23, 24 is coupled to au opposing node of a diode ring 21. Two other opposing nodes of the diode ring are connected to differential input terminals 25, 26 of an output transformer 22. A centre tap 27 of the primary winding of the output transformer 22 is connected to earth. A sine ended output terminal of the transformer 22 is coupled to the diplexer, while the other output terminal is grounded. It should be noted that somebody skilled in this area of technology would appreciate that the input and output transformers could be replaced by baluns.

FIG. 3 shows a circuit diagram of the DBDM 12 shown in FIG. 2. The input transformer 20 includes a primary winding 30 with a differential input and a centre tapped differential secondary winding 31. Similarly the output transformer 22 includes a centred tapped differential input primary winding 32 and a single ended secondary winding 33. The diode ring consists of four diodes arranged such that only two of the diodes conduct at any one time depending on the polarity of the LO signals at the nodes 34, 36. The filtered input signal 15 is fed into one terminal of a primary winding 30 of the input transformer 20. The differential output terminals 38a, 38b of the secondary winding 31 are coupled to opposite nodes 34, 36 of the diode ring while the two other opposing nodes 35, 37 are coupled to the differential inputs terminals 39a, 39b of the primary winding 32 of the output transformer 22.

The LO signal 16 is fed into the centre tap 38c of the input transformer 20 secondary winding 31 and in turn fed into the diode ring 21 to input nodes 34, 36 via the differential output terminals 38a, 38b. The single ended output signal 17 is generated on an output terminal of the output transformer's 22 secondary winding 33, while the other output terminal is earthed. During operation of the mixer 10 the LO signal 16 is fed into the diode ring and alternately switches opposing diode pairs on and off which alternates the differential RF output signal 23, 24 between the differential input terminals 39a, 39b of the output transformer 22. It will be appreciated by those skilled in the art that in an alternative embodiment the LO 16 could readily be injected into a centre tap 39c of the primary winding 32 of the output transformer 22 with the centre tap 38c of the primary winding 31 of the input transformer 20 being connected to ground. Either configuration of LO 16 and ground connections to the centre taps 38c, 39c can be used as required. One configuration may be preferable to the other in certain implementations.

FIG. 4 shows a typical diplexer 13 used in the mixing circuit 10. The diplexer 13 includes a single ended input terminal 40 for receiving a mixed signal from the DBDM 12. A typical signal 17 from the DBDM 12 will include RF, LO and IF portions of which the RF and LO portions require removal and termination. A LCR filter network 41 provides a terminating load for all signals other than the wanted IF signal which is filtered and passed to the IF output terminal 42.

FIG. 5 is a block diagram of a preferred embodiment of the invention in which a modified output circuit 50 is implemented which approximates the combined functionality of the diplexer 13 and output transformer 22 as encircled 28 in FIG. 2. Effectively the circuit is an LCR model, or equivalent circuit, of the diplexer 13 and transformer 22. Alternatively the equivalent circuit could be implemented using microstrip technology. The modified output circuit 50 generates a single ended output which can be utilised by telecommunications equipment as required. The modified circuit 50 can be directly substituted for the diplexer 13 and output transformer 22 which are typically used in a mixing circuit 10. In the preferred embodiment the LO signal 16 is injected into the circuit via the centre tap on the input transformer 20.

FIG. 6 is a circuit diagram of a preferred embodiment of the modified output circuit 50. The LCR equivalent circuit 50 includes two input terminals 60, 61 for receiving the mixed differential signal 24, 26 from the diode ring 21. The differential signal 25, 26 comprises RF and IF components along with in phase LO signals. The RC 62 portion of the circuit is designed using known techniques to provide a good termination at RF frequencies for differential signals. In this manner the RF frequencies are dissipated across the resistor. Capacitors 65 remove any LO or RF signal component from the output 69. Inductors 63, 64 provide series impedance for RF and LO signals. For the LO signals this inductance can be tuned out by the series capacitance 29 in the LO feed to the mixer 16. This leaves the IF components of the differential input signals 24, 26 remaining in the circuit. The series capacitors 65 in parallel with an inductor 66 provide an equivalent circuit of the output transformer 22 which approximates the functionality of the transformer 22. The circuit 68 is parallel resonant at IF frequencies to convert the remaining IF portion of the differential input signal 24, 26 into a single ended IF output signal which appears on an output terminal 69.

1. An output stage for a mixing circuit including:
input terminals for a differential input signal,
a single ended output terminal, and
a LCR network coupled between the input and output terminals,
wherein the LCR network implements a filter and termination which extracts a portion of the differential input signal and further implements an equivalent circuit for a transformer which generates a single ended output signal from extracted portions of the differential input signal.

2. An output stage according to claim 1 wherein the differential input signal includes RF components, an oscillator component, and IF components.

3. An output stage according to claim 2 wherein a filter portion of the LCR network removes the local oscillator component from the differential input signal and a farther portion of the LCR network terminates the RF components of the input signal.

4. An output stage according to claim 3 wherein the transformer equivalent circuit portion of the LCR network includes two series capacitors in parallel with an inductor.

5. An output stage according to claim 4 wherein the capacitors and inductor are parallel resonant at IF.

6. A method of generating a single ended IF output signal from a differential input signal including:
receiving differential input signals,
extracting IF components from the differential signals, and
generating a single ended IF output signal from the extracted IF components, wherein the IF output signal is generated using an LC network which approximates the functionality of a differential output transformer.

7. A method according to claim 6 wherein the LC network is parallel resonant at IF.

8. A method according to claim 7 wherein the LC network includes two series capacitors in parallel with an inductor.

9. An method according to claim 8 wherein the differential input signal includes RF components, an oscillator component, and IF components.

10. A method according to claim 8 wherein extracting the IF components includes terminating the RF components and filtering the local oscillator component.

11. An output stage for a mixing circuit substantially as hereinbefore described with reference to the accompanying drawings.

12. A method of generating a single ended IF output signal from a differential input signal substantially as hereinbefore described with reference to the accompanying drawings.
